(19) United States
(12) Patent Application Publication
(10) Pub. No.: US 2024/0221994 A1
(43) Pub. Date: Jul. 4, 2024

(54) COIIL COMPONENT

(71) Applicant: SAMSUNG ELECTRO-MECHANICS CO., LTD., Suwon-si (KR)

(72) Inventors: Min Ji Cho, Suwon-si (KR); Ji Man Ryu, Suwon-si (KR)

(73) Assignee: SAMSUNG ELECTRO-MECHANICS CO., LTD., Suwon-si (KR)

(21) Appl. No.: 18/538,396

(22) Filed: Dec. 13, 2023

(30) Foreign Application Priority Data
Dec. 30, 2022 (KR) 10-2022-0190945

(51) Int. Cl. H01F 27/28; H01F 5/04

(52) U.S. Cl. CPC H01F 27/2847; H01F 5/04

(57) ABSTRACT

A coil component includes a support member, a first coil pattern, a second coil pattern, a body in which the support member and the first and second coil patterns are embedded, and a via extending in the third direction and connecting the first and second coil patterns, wherein an innermost turn of the plurality of turns of the first coil pattern includes first and half turns, the width of the first half turn is smaller than the width of the second half turn, and the width of the second half turn is greater than the width of the region where the first and second half turns are connected.

### CROSS-REFERENCE TO RELATED APPLICATION(S)

This application claims benefit of priority to Korean Patent Application No. 10-2022-0190945 filed on Dec. 30, 2022 in the Korean Intellectual Property Office, the disclosure of which is incorporated herein by reference in its entirety.

### TECHNICAL FIELD

The present disclosure relates to a coil component.

An inductor, a type of coil component, is a typical passive electronic component used in electronic devices along with resistors and capacitors.

In the case of a thin film coil component, a type of coil component, a coil pattern is formed on a support member through a thin film process, such as a plating process, and one or more magnetic composite sheets are laminated on the support member on which the coil pattern is formed to form a body, and an external electrode is formed on the body.

Inductance of the coil pattern may increase as the total number of turns of the coil pattern increases, and the total number of turns of the coil pattern in unit area may increase as the width of the coil pattern decreases.

Energy loss in the coil pattern may decrease as equivalent series resistance of the coil pattern decreases, and the equivalent series resistance of the coil pattern in unit area may decrease as a thickness of the coil pattern increases.

Accordingly, an aspect ratio (A/R), which is a thickness/width ratio of the coil pattern, may increase. However, as the aspect ratio of the coil pattern increases, geometrical stability of the coil pattern may become more important. For example, when geometrical stability is not secured, the coil pattern may collapse and the coil pattern may be unwound.

### SUMMARY

An aspect of the present disclosure is to provide a coil component having improved geometrical stability of a coil pattern and an increased aspect ratio of the coil pattern.

According to an aspect of the present disclosure, a coil component includes a support member, a first coil pattern disposed on one surface of the support member and having a plurality of turns, a second coil pattern disposed on the other surface of the support member and having a plurality of turns, a body in which the support member and the first and second coil patterns are embedded and having first and second surfaces facing each other in a first direction, third and further surfaces facing each other in a second direction, and fifth and sixth surfaces facing each other in a third direction, and a via extending in the third direction and connecting the first and second coil patterns.

An innermost turn of the plurality of turns of the first coil pattern includes a first half turn connected to the via and a second half turn connected to the first half turn, in the first-third direction cross-section of the body cut in the center thereof in the second direction, the width of the first half turn is smaller than the width of the second half turn, and the width of the second half turn in the first direction-third direction cross-section is greater than the width of the region where the first and second half turns are connected.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to an exemplary embodiment in the present disclosure;

FIG. 2 is a cross-sectional view illustrating a cross-section taken along line I-I′ of FIG. 1;

FIG. 3 is a cross-sectional view illustrating a cross-section taken along line II-II′ of FIG. 1;

FIGS. 4A to 4E are plan views illustrating various forms of coil patterns of coil components according to an exemplary embodiment in the present disclosure;

FIGS. 5A and 5B are cross-sectional views illustrating a method of manufacturing a coil pattern of a coil component according to an exemplary embodiment in the present disclosure;

FIG. 6A is an enlarged view of region A of FIG. 2;

FIG. 6B is a cross-sectional view schematically illustrating a first modified example of region A of FIG. 2; and

FIG. 6C is a cross-sectional view schematically illustrating a second modified example of region A of FIG. 2.

### DETAILED DESCRIPTION

The terms used in the present specification are merely used to describe particular exemplary embodiments and are not intended to limit the present disclosure. An expression used in the singular encompasses the expression of the plural, unless it has a clearly different meaning in the context. In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. Also, throughout the specification, “on” means to be located above or below a target portion and does not necessarily mean to be located on the upper side with respect to the direction of gravity.

In addition, coupling does not mean only the case of direct physical contact between each component in a contact relationship, but should be used as a concept that encompasses even a case in which another component intervenes between each component so that a component is in contact with the other component.

Since the size and thickness of each component illustrated in the drawings are arbitrarily illustrated for convenience of description, the present disclosure is not necessarily limited to the illustrated.

In the drawings, an L direction may be defined as a first direction or length direction, a W direction may be defined as a second direction or width direction, and a T direction may be defined as a third direction or thickness direction.

Hereinafter, a coil component according to an exemplary embodiment in the present disclosure will be described in detail with reference to the accompanying drawings, and in the description with reference to the accompanying drawings, the same or corresponding components are assigned the same reference numerals and overlapping descriptions thereof will be omitted.

Various types of electronic components are used in electronic devices, and various types of coil components may be appropriately used between these electronic components for the purpose of removing noise.

That is, in electronic devices, coil components may be used as power inductors, high-frequency (HF) inductors, general beads, GHz beads, common mode filters, etc.

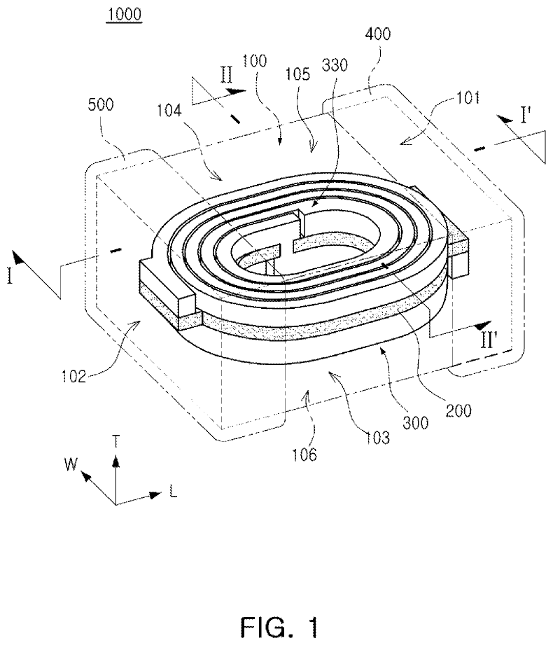

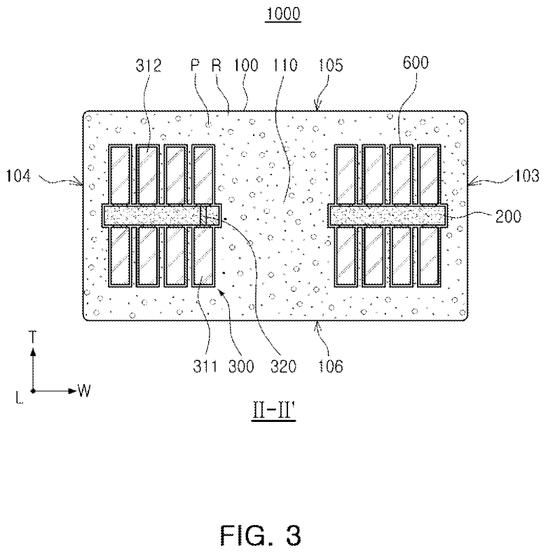

Referring to FIGS. 1 to 3, a coil component 1000 according to an exemplary embodiment in the present disclosure may include a body 100, a support member 200, and a coil unit 300, and may further include external electrodes 400 and 500 and at least one of the insulating film 600.

The body 100 may form the overall appearance of the coil component 1000 according to the present exemplary embodiment, and the support member 200 and the coil unit 300 may be embedded therein. The body 100 may have a shape of a hexahedron as a whole.

Referring to FIGS. 1 to 3, the body 100 includes a first surface 101 and a second surface 102 facing each other in the first direction L (e.g., length direction), a third surface 103 and a fourth surface 104 facing each other in the second direction W (e.g., width direction), and a fifth surface 105 and a sixth surface 106 facing each other in the third direction T (e.g., thickness direction). Each of the first to fourth surfaces 101, 102, 103, and 104 of the body 100 corresponds to a wall surface of the body connecting the fifth surface 105 and the sixth surface 106 of the body 100. Hereinafter, both end surfaces of the body 100 may refer to the first surface 101 and the second surface 102 of the body 100, both side surfaces of the body 100 may refer to the third surface 103 and the fourth surface 104 of the body 100, and one surface of the body may refer to the sixth surface 106, and the other surface of the body 100 may refer to the fifth surface 105. In addition, in the following, upper and lower surfaces of the body 100 may refer to the fifth surface 105 and the sixth surface 106 of the body 100, which are determined based on the directions of FIGS. 1 to 3, respectively.

For example, the body 100 may be formed so that the coil component 1000 according to the present exemplary embodiment, on which external electrodes 400 and 500 to be described below are formed, has a length of 1.035 mm, a width of 0.76 mm, and a thickness of 0.615 mm, but is not limited thereto. To this end, the body 100 may be formed to have a length of 0.975 mm, a width of 0.705 mm to 0.72 mm, and a thickness of 0.58 mm, but is not limited thereto.

The body 100 may include magnetic powder particles P and an insulating resin R. Specifically, the body 100 may be formed by laminating one or more magnetic composite sheets including the insulating resin R and the magnetic powder particles P dispersed in the insulating resin R and then curing the magnetic composite sheets. However, the body 100 may have a structure other than the structure in which the magnetic powder particles P are dispersed in the insulating resin R. For example, the body 100 may be formed of a magnetic material, such as ferrite.

The magnetic powder particles P may be, for example, ferrite or magnetic metal powder particles.

The ferrite powder particles may be at least one of, for example, Mg—Zn-based, Mn—Zn-based, Mn—Mg-based, Cu—Zn-based, Mg—Mn—Sr-based, Ni—Zn-based spinel ferrite, Ba—Zn-based, Ba—Mg-based, Ba—Ni-based, Ba—Co-based, and Ba—Ni—Co-based hexagonal ferrites, garnet-type ferrites, such as Y-based ferrites, and Li-based ferrites.

The metal magnetic powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, metal magnetic powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo— Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles.

The magnetic metal powder particles may be amorphous or crystalline. For example, the magnetic metal powder particles may be Fe—Si—B—Cr-based amorphous alloy powder particles, but are not limited thereto.

Each of the ferrite and magnetic metal powder particles may have an average diameter of about 0.1 μm to about 30 μm, but is not limited thereto.

The body 100 may include two or more types of magnetic powder particles P dispersed in the insulating resin R. Here, the different types of magnetic powder particles P means that the magnetic powder particles P dispersed in the insulating resin R are distinguishable from each other by one of diameter, composition, crystallinity, and shape. For example, the body 100 may include two or more magnetic powder particles P having different diameters.

The insulating resin R may include epoxy, polyimide, liquid crystal polymer, etc., alone or in combination, but is not limited thereto.

The body 100 includes a core 110 penetrating through the support member 200 and the coil unit 300 to be described below. The core 110 may be formed by filling a through-hole of the coil unit 300 with at least a portion of the magnetic composite sheet in the process of laminating and curing the magnetic composite sheet, but is not limited thereto.

The support member 200 is embedded in the body 100.

The support member 200 supports the coil unit 300 to be described below.

The support member 200 may be formed of an insulating material including a thermosetting insulating resin, such as an epoxy resin, a thermoplastic insulating resin, such as polyimide, or a photosensitive insulating resin, or an insulating material impregnated with a reinforcing material, such as glass fiber or inorganic filler in such an insulating resin. For example, the support member 200 may be formed of an insulating material, such as copper clad laminate (CCL), prepreg, Ajinomoto build-up film (ABF), FR-4, bismaleimide triazine (BT) film, photo imageable dielectric (PID) film, but is not limited thereto.

As inorganic fillers, at least one selected from the group consisting of silica (SiO₂), alumina (Al₂O₃), silicon carbide (SiC), barium sulfate (BaSO₄), talc, clay, mica powder particles, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed of an insulating material including a reinforcing material, the support member 200 may provide superior rigidity. When the support member 200 is formed of an insulating material that does not contain glass fibers, the support member 200 is advantageous in reducing the overall thickness of the coil unit 300. When the support member 200 may be formed of an insulating material including a photosensitive insulating resin, the number of processes for forming the coil unit 300 may be reduced, which is advantageous in reducing production costs, and it is possible to form fine vias. The thickness of the support member 200 may be greater than 20 μm and less than 40 μm, more preferably, greater than or equal to 25 μm and less than 35 μm, but is not limited thereto.

The coil unit 300 includes planar spiral first and second coil patterns 311 and 312 disposed on the support member 200 and is embedded in the body 100 to manifest characteristics of the coil component. For example, when the coil component 1000 of the present exemplary embodiment is used as a power inductor, the coil unit 300 may maintain an output voltage by storing an electric field as a magnetic field, thereby stabilizing power of an electronic device.

The coil unit 300 includes first and second coil patterns 311 and 312 and a via 320. Specifically, the first coil pattern 311 is disposed on a lower surface of the support member 200 facing the sixth surface 106 of the body 100 based on the directions of FIGS. 1, 2 and 3, and the second coil pattern 312 is disposed on an upper surface of the support member 200. The via 320 extends in the third direction and passes through the support member 200 to be in contact with and connected to the first coil pattern 311 and the second coil pattern 312. Accordingly, the coil unit 300 may function as a single coil in which one or more turns are formed around the core 110 as a whole.

The via 320 may include at least one conductive layer. For example, when the via 320 is formed by electroplating, the via 320 may include a seed layer formed on an inner wall of a via hole penetrating through the support member 200 and an electroplating layer filling the via hole in which the seed layer is formed. The seed layer of the via 320 and a seed layer (a first conductive layer to be described below) for forming the first and second coil patterns 311 and 312 may be formed together in the same process and integrally formed with each other, or may be formed in different processes to have a boundary formed therebetween. The via 320 may include a conductive material, such as copper (Cu), aluminum (Al), silver (Ag), tin (Sn), gold (Au), nickel (Ni), lead (Pb), titanium (Ti), chromium (Cr), molybdenum (Mo), or alloys thereof.

First and second lead-out patterns 311e and 312e of the first and second coil patterns 311 and 312 may be connected to the first and second external electrodes 400 and 500, respectively. For example, the first lead-out pattern 311e of the first coil pattern 311 may be exposed to the first surface 101 of the body 100 and contact and be connected to the first external electrode 400. For example, the second lead-out pattern 312e of the second coil pattern 312 may be exposed to the second surface 102 of the body 100 and contact and be connected to the second external electrode 500.

The external electrodes 400 and 500 may have a monolayer or multilayer structure. For example, the first external electrode 400 may include a first layer including copper (Cu), a second layer disposed on the first layer and including nickel (Ni), and a third layer disposed on the second layer and including tin (Sn). Here, each of the first to third layers may be formed by plating, but is not limited thereto. As another example, the first external electrode 400 may include a resin electrode including conductive powder particles, such as silver (Ag), and a resin and a nickel (Ni)/tin (Sn) plating layer plated on the resin electrode.

The external electrodes 400 and 500 may be formed of a conductive material, such as copper (Cu), aluminum (Al), silver (Ag), tin (Sn), gold (Au), nickel (Ni), lead (Pb), titanium (Ti), or alloys thereof, but is not limited thereto.

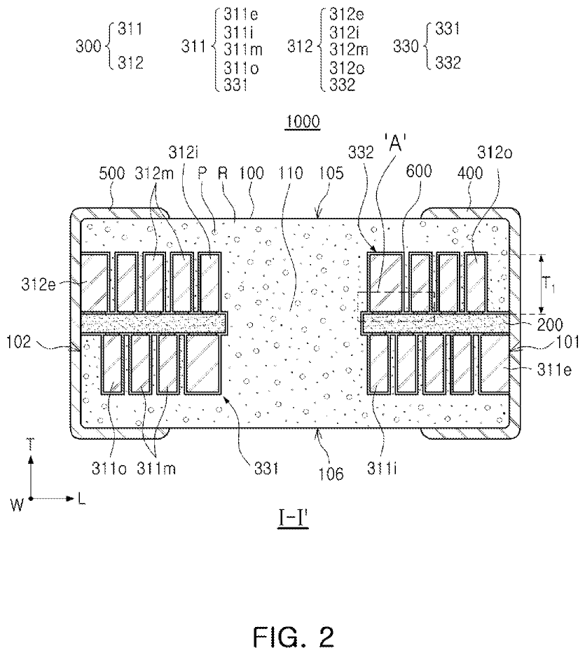

The first and second coil patterns 311 and 312 each have a planar spiral shape in which at least one turn is formed around the core 110 as an axis. For example, the first coil pattern 311 may form at least one turn with the core 110 as an axis on the lower surface of the support member 200 based on the direction of FIG. 2.

Referring to FIGS. 1, 2, 3, and 4A, the coil unit 300 may include upper and lower matching portions 330, and the first coil pattern 311 may include the first upper and lower matching portions 331 and the second coil pattern 312 may include second upper and lower matching portions 332. The upper and lower matching portions 330 may include first and second upper and lower matching portions 331 and 332.

The via 320 may include a first portion 321 and a second portion 322 overlapping each other in a direction (e.g., a T direction) in which one surface and the other surface of the support member 200 face each other, and the first and second portions 321 and 322 of the via 320 may be in the form of a pad having widths W1 and W11, respectively.

One of the first and second coil patterns 311 and 312 may be wound clockwise from one of the first and second portions 321 and 322 of the via 320, and the other of the first and second coil patterns 311 and 312 may be wound counterclockwise from the other of the first and second portions 321 and 322 of the via 320. When there are no upper and lower matching portions 330, non-overlapping portions that do not overlap each other in a direction in which one surface and the other surface of the support member 200 face each other in innermost turns 311i and 312i of the first and second coil patterns 311 and 312 may be generated by an area sufficient to affect the geometrical stability of the first and second coil patterns 311 and 312.

Since the upper and lower matching portions 330 may reduce the area of the non-overlapping portions, the geometrical stability may be improved, and since the coil component 1000 according to an exemplary embodiment in the present disclosure may be advantageous to increase the aspect ratio of the first and second coil patterns 311 and 312, the coil component 1000 may have large inductance or high energy efficiency, compared to the size of the coil component 1000.

In this embodiment, an innermost turn of the plurality of turns of the first coil pattern 311 includes a first half turn connected to the via 320 and a second half turn connected to the first half turn, in the first-third direction (L-T) cross-section of the body 100 cut in the center thereof in the second direction (W direction), the width of the first half turn is smaller than the width of the second half turn, and the width of the second half turn in the first direction-third direction (L-T) cross-section is greater than the width of the region where the first and second half turns are connected. Moreover, an innermost turn of the plurality of turns of the second coil pattern 312 may include a first half turn connected to the via 320 and a second half turn connected to the first half turn of the second coil pattern 312, in the first-third (L-T) direction cross-section of the body 100 cut in the center thereof in the second direction (W direction), the width of the first half turn of the second coil pattern 312 is smaller than the width of the second half turn of the second coil pattern 312, and the width of the second half turn of the second coil pattern in the first direction-third direction (L-T) cross-section may be greater than the width of the region where the first and second half turns of the second coil pattern 312 are connected.

In an exemplary embodiment, the width of the second half turn of the first coil pattern 311 may narrow as it is closer to the first half turn of the first coil pattern 311. Likewise, the width of the second half turn of the second coil pattern 312 may narrow as it is closer to the first half turn of the second coil pattern 312. As depicted, the first and second half turns of the first coil pattern 311 may have curved regions, respectively, facing each other in the first direction (L direction), and an average width of the curved region of the first half turn may be smaller than an average width of the curved region of the second half turn. Likewise, the first and second half turns of the second coil pattern 312 may have curved regions, respectively, facing each other in the first direction (L direction), and an average width of the curved region of the first half turn is smaller than an average width of the second half turn.

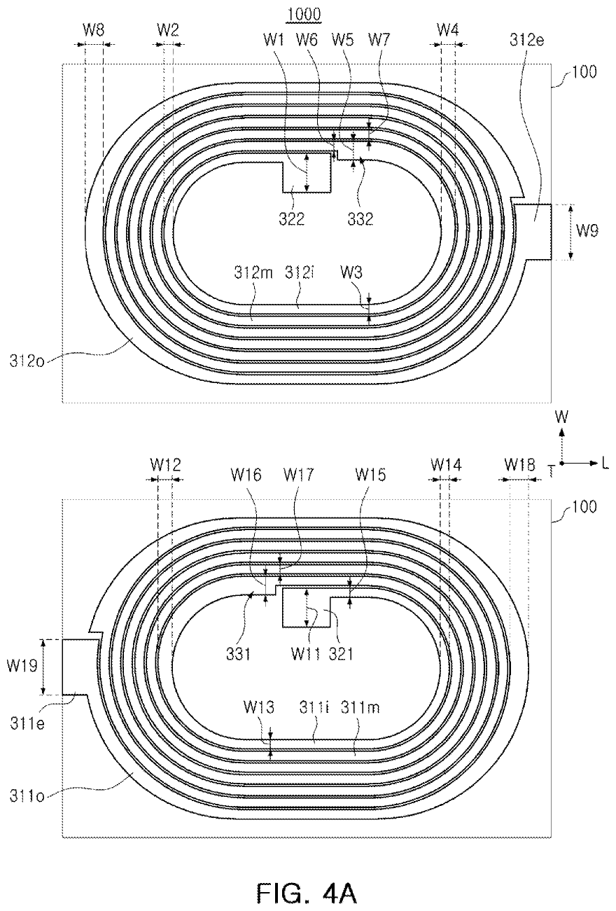

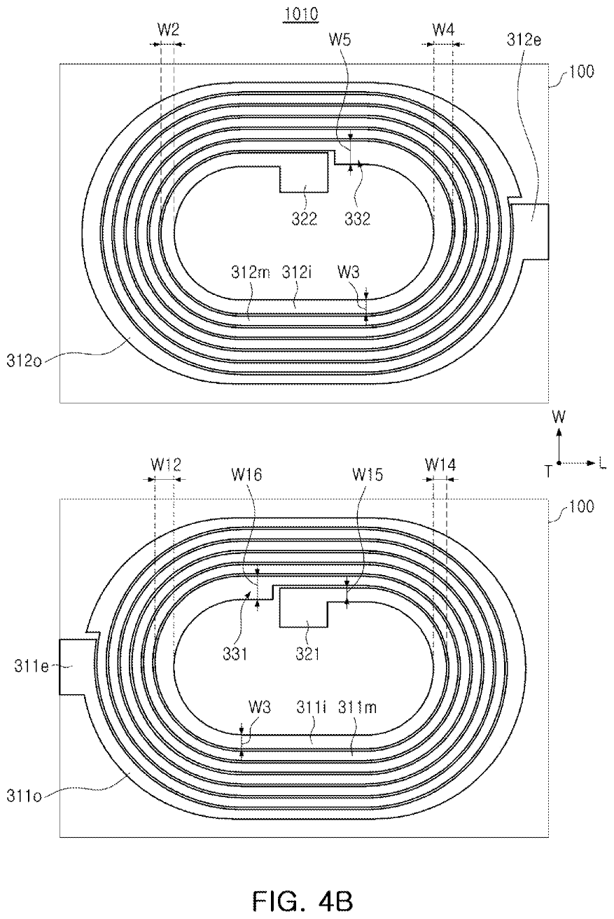

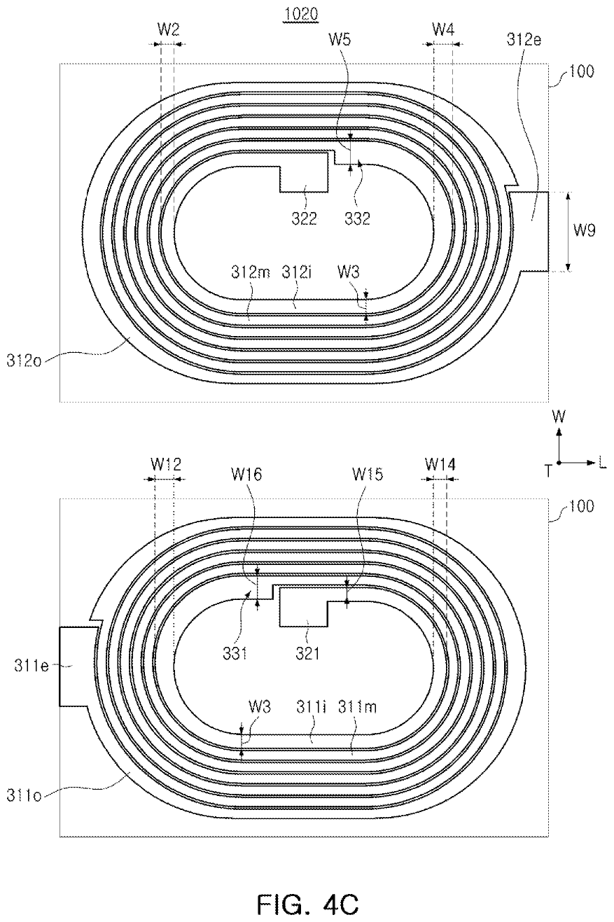

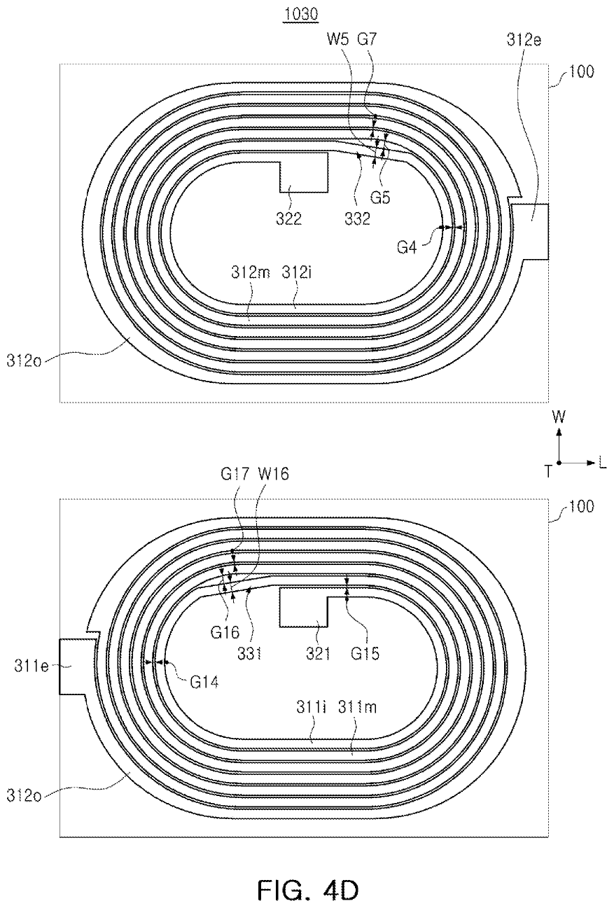

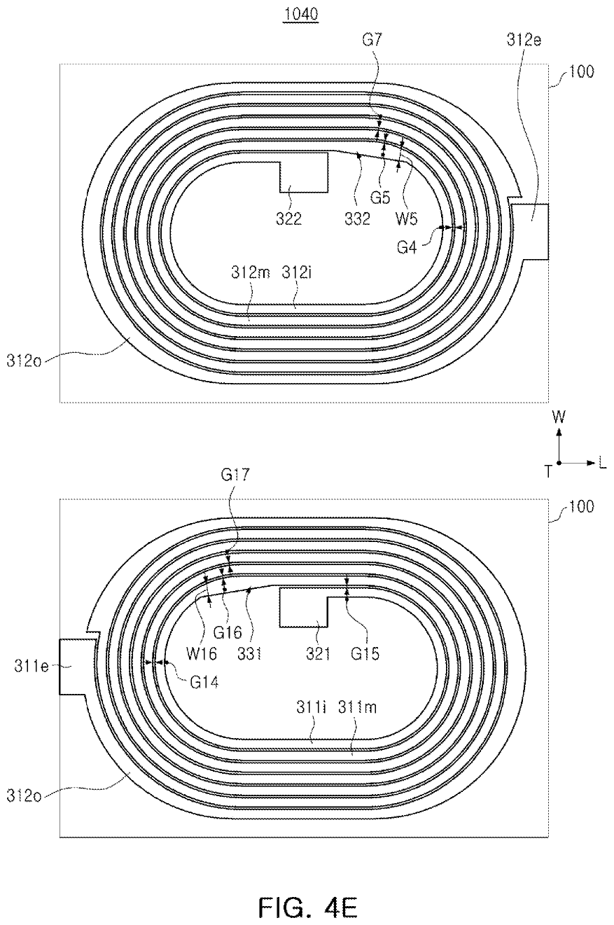

According to an exemplary embodiment of the first upper and lower matching portion 331, an average width ((W16+W12+W13)/3) of a partial turn (e.g., the second half turn based on FIG. 4A) electrically connected to be farther from the first portion 321 of the via 320 among two partial turns of the innermost turn 311i of the plurality of turns of the first coil pattern 311, may be greater than an average width ((W15+W14+W13)/3) of a partial turn (e.g., the first half turn based on FIG. 4A) electrically closer connected to the first portion 321 of the via 320 among the two partial turns. When further optimized, the average width ((W16+W12+W13)/3) may be greater than or equal to 1.25 times and less than or equal to 1.75 times the average width ((W15+W14+W13)/3). For example, W16 may be about 2 times each of W13, W14, and W15, W12 may be about 1.5 times each of W13, W14, and W15, and each of W13, W14, and W15 may be about 15 μm, but are not limited thereto. For example, W16 may be about 32 μm.

According to an exemplary embodiment of the second upper and lower matching portion 332, an average width ((W5+W4+W3)/3) of a partial turn (e.g., the second half turn based on FIG. 4A) electrically farther connected from the second portion 322 of the via 320 among the two partial turns of the innermost turn 312i of the plurality of turns of second first coil pattern 312 may be greater than an average width ((W2+W3)/2) of a partial turn (e.g., the first half turn based on FIG. 4A) electrically connected to be closer to the second portion 322 of the via 320 among the two partial turns. When further optimized, the average width ((W5+W4+W3)/3) may be greater than or equal to 1.25 times and less than or equal to 1.75 times the average width ((W2+W3)/2). For example, W5 may be about 2 times W2 and W3, W4 may be about 1.5 times each of W2 and W3, and each of W2 and W3 may be about 15 μm, but is not limited thereto. For example, W5 may be about 32 μm.

Alternatively, according to an exemplary embodiment of the first upper and lower matching portion 331, in the first half turn (right side based on FIG. 4A) electrically connected to be closer to the first portion 321 of the via 320 among two half turns of the innermost turn 311i of the plurality of first coil pattern 311, a ratio of an area (in a direction (e.g., the T direction) in which one surface and the other surface of the support member 200 face each other) overlapping the second half turn (right side based on FIG. 4A) electrically connected to be farther from the first portion 321 of the via 320 among two half turns of the innermost turn 312i of the plurality of turns of the second coil pattern 312 to the total area of the surface (e.g., an upper surface) facing the support member 200 may exceed half (50%). When further optimized, the ratio may exceed 75%.

Alternatively, according to an exemplary embodiment of the second upper and lower matching portion 332, a ratio of an area overlapping (in a direction (e.g., the T direction) in which one surface and the other surface of the support member 200) face each other) the second half turn (left side based on FIG. 4A) electrically connected to be farther from the second portion 322 of the via 320 among the two half turns of the innermost turn 311i of the plurality of turns of the first coil pattern 311 to the total area of a surface (e.g., a lower surface) facing the support member 200 in the first half turn (left side based on FIG. 4A) electrically connected to be closer to the second portion 322 of the via 320 among the two half turns of the innermost turn 312i of the plurality of turns of the second coil pattern 312 may exceed half. When further optimized, the ratio may exceed 75%.

A boundary point between two partial turns of the innermost turns 311i and 312i of the first and second coil patterns 311 and 312 may be a point that meets a straight line extending in a direction (e.g., a −W direction) opposite to a direction (e.g., a +W direction) toward the via 320 from the center of the core 110, which is a space surrounded by the innermost turns 311i and 312i.

Accordingly, winding lengths of the two partial turns may be substantially equal to each other, and may vary slightly depending on the size or shape of the first and second portions 321 and 322 of the via 320. Each of the two partial turns may surround the center of the core 110 by about an angle of 180 degrees. Depending on the design, a width of a portion of a wider partial turn of the two partial turns may be substantially the same as a width of a narrower partial turn. Therefore, the boundary point between the two partial turns is not limited to the point at which the innermost turns 311i and 312i start to widen.

For example, an average width ((W16+W12+W13)/3) of a partial turn (e.g., the second half turn based on FIG. 4A) electrically connected to be farther from the first portion 321 of the via 320 among the two partial turns of the innermost turn 311i of the first coil pattern 311 may be narrower as it is electrically closer to the partial turn (e.g., the first half turn based on FIG. 4A) electrically connected to be closer to the first portion 321 of the via 320 among the two partial turns of the innermost turn 311i of the first coil pattern 311. For example, W12 may be narrower than W16, and W13 may be narrower than W12. Accordingly, since the first upper and lower matching portion 331 may gradually widen the width of the innermost turn 311i, the geometrical stability of the innermost turn 311i may be more stably improved.

For example, an average width of a partial turn (the right partial turn based on FIG. 4A) electrically connected to be farther from the second portion 322 of the via 320 among the two partial turns of the innermost turn 312i of the second coil pattern 312 may be narrower as it is electrically closer to a partial turn (e.g., a left partial turn based on FIG. 4A) electrically connected to be closer to the second portion 322 of the via 320 among the two partial turns of the innermost turn 312i of the second coil pattern 312. For example, W4 may be narrower than W5, and W3 may be narrower than W4. Accordingly, since the second upper and lower matching portions 332 may gradually widen the width of the innermost turn 312i, the geometrical stability of the innermost turn 312i may be more stably improved.

For example, an average width ((W16+W12+W13)/3) of a partial turn (e.g., the second half turn based on FIG. 4A) electrically connected to be farther from the first portion 321 of the via 320 among the two partial turns of the innermost turn 311i of the first coil pattern 311 may be greater than an average width ((W2+W3)/2) of a partial turn (the first half turn based on FIG. 4A) electrically connected to be closer to the second portion 322 of the via 320 among the two partial turns of the innermost turn 312i of the second coil pattern 312. Accordingly, the first upper and lower matching portions 331 may reduce the area of the non-overlapping portions between the innermost turn 311i and the innermost turn 312i and improve the geometrical stability of the innermost turns 311i and 312i.

For example, an average width ((W5+W4+W3)/3) of a partial turn (e.g., the second half turn based on FIG. 4) electrically connected to be farther from the second portion 322 of the via 320 among the two partial turns of the innermost turn 312i of the second coil pattern 312 may be greater than an average width ((W15+W14+W13)/3) of a partial turn (e.g., the first half turn based on FIG. 4A) electrically connected to be closer to the first portion 321 of the via 320 among the two partial turns of the innermost turn 311i of the first coil pattern 311. Accordingly, the second upper and lower matching portions 332 may reduce the area of the non-overlapping portions between the innermost turn 311i and the innermost turn 312i and improve the geometrical stability of the innermost turns 311i and 312i.

For example, a width W18 of the outermost turn 311o of a plurality of turns of the first coil pattern 311 may be greater than a width W17 of a second inner turn 311m of the first coil pattern 311, and a width W8 of the outermost turn 312o of the plurality of turns of the second coil pattern 312 may be greater than an average width (an average value of W6 and W7) of the second inner turn 312m of the second coil pattern 312. Accordingly, the outermost turns 311o and 312o may improve overall geometrical stability of the first and second coil patterns 311 and 312, and thus, reference geometrical stability required for the innermost turns 311i and 312i may be reduced, and the degree of freedom in designing the width or shape of the first and second upper and lower matching portions 331 and 332 may be further improved. As the degree of freedom in the design of the first and second upper and lower matching portions 331 and 332 is higher, the performance (e.g., energy efficiency, difficulty in miniaturizing the body, robustness against process variation, etc.) of the innermost turns 311i and 312i may be improved more efficiently.

Referring to FIG. 4B, an average width ((W15+W14+W13)/3) of a partial turn (right side based on FIG. 4B) electrically connected to be closer to the first portion 321 of the via among the two partial turns of the innermost turn 311i of the first coil pattern of a coil component 1010 according to an exemplary embodiment in the present disclosure may be greater than a width (W17 of FIG. 4A) of the second inner turn 311m of the first coil pattern, and an average width ((W2+W3)/2) of the partial turn (left side based on FIG. 4B) electrically connected to be closer to the second portion 322 of the via among the two partial turns of the innermost turn 312i of the second coil pattern may be greater than an average width (an average value of W6 and W7 of FIG. 4A) of the second inner turn 312m of the second coil pattern. Accordingly, the innermost turns 311i and 312i may improve the overall geometrical stability of the first and second coil patterns 311 and 312 and may further improve the degree of freedom in designing the width or shape of the first and second upper and lower matching portions 331 and 332. For example, each of W2, W14, and W15 in FIG. 4B may be 16 μm or more and 30 μm or less, or may be further optimized to be 20 μm or more and 25 μm or less.

Referring to FIG. 4C, the first coil pattern 311 of a coil component 1020 according to an exemplary embodiment in the present disclosure may further include a first lead-out pattern 311e connected to the outermost turn 311o and exposed to the surface of the body 100, and the second coil pattern 312 may further include a second lead-out pattern 312o connected to the outermost turn 312o and exposed to the surface of the body 100.

A width (corresponding to W19 in FIG. 4A) of the first lead-out pattern 311e may be greater than or equal to 9 times a width (W17 in FIG. 4A) of a second inner turn 311m of the first coil pattern 311, and a width W9 of the second lead-out pattern 312e may be greater than or equal to 9 times a width (an average value of W6 and W7 in FIG. 4A) of the second inner turn 312m of the second coil pattern 312.

Accordingly, the first and second lead-out patterns 311e and 312e may improve the overall geometrical stability of the first and second coil patterns 311 and 312, and thus, the reference geometrical stability required for the innermost turns 311i and 312i may be reduced, and the degree of freedom in designing the width or shape of the first and second upper and lower matching portions 331 and 332 may be further improved. For example, W9 in FIG. 4C may be about 160 μm.

Referring to FIGS. 4A, 4B, and 4C, an edge surrounding the first portion 321 of the via may have a step in a partial turn electrically connected to be farther from the first portion 321 of the via among the two partial turns of the innermost turn 311i of the first coil pattern 311, and an edge surrounding the second portion 322 of the via may have a step in a partial turn electrically connected to be farther from the second portion 322 of the via among the two partial turns of the innermost turn 312i of the second coil pattern 312. The step may be formed at the end point of each of the innermost turns 311i and 312i as the first and second upper and lower matching portions 331 and 332 gradually widen the innermost turns 311i and 312i, and the width may be rapidly narrowed at the end point of each of the innermost turns 311i and 312i. The step may reduce overall design changes of the first and second coil patterns 311 and 312 according to the additional implementation of the first and second upper and lower matching portions 331 and 332, and thus, implementation stability of performance (e.g., energy efficiency, inductance, etc.) of the first and second coil patterns may be improved.

Depending on a winding structure of each portion of the first and second coil patterns 311 and 312, at least a portion of the edge of the first and second coil patterns 311 and 312 may be curved. The step refers to that the curve is more angular than a point at which the curve is maximized. The angular angle of the angled shape may be close to 90 degrees, but is not limited thereto.

Meanwhile, an edge surrounding the first lead-out pattern 311e at the outermost turn 311o of the plurality of turns of the first coil pattern may have a step, and an edge surrounding the second lead-out pattern 312e at the outermost turn 312o of the plurality of turns of the second coil pattern may have a step.

Referring to FIGS. 4D and 4E, the innermost turns 311i and 312i of the first and second coil patterns 311 and 312 of the coil components 1030 and 1040 according to an exemplary embodiment in the present disclosure may reduce a non-overlapping area between the first and second coil patterns 311 and 312, even without a step.

Referring to FIG. 4D, according to the first upper and lower matching portions 331, a distance ((G16+G14)/2) between a partial turn (the second half turn based on FIG. 4A) electrically connected to be farther from the first portion 321 of the via among the two partial turns of the innermost turn 311i of the first coil pattern 311 and the second inner turn 311m may be longer than a distance G15 between a partial turn (the first half turn based on FIG. 4A) electrically connected to be closer to the first portion 321 of the via among the two partial turns of the innermost turn 311i of the first coil pattern 311 and the second inner turn 311m. Each of G14, G15, and G17 may be about 8 μm, but is not limited thereto. G16 of FIG. 4E may be shorter than G16 of FIG. 4D and may be substantially the same as G14, G15, and G17. In addition, in the first and second upper and lower matching portions 331 and 332 of FIG. 4D, although the widths W5 and W16 of the innermost turns 311i and 312i are not increased, compared to widths of other portions, a non-overlapping area between the first and second coil patterns 311 and 312 may be reduced and geometrical stability of the innermost turns 311i and 312i may be improved.

Referring to FIG. 4D, according to the second upper and lower matching portions 332, a distance ((G5+G4)/2) between a partial turn (the second half turn) based on FIG. 4) electrically connected to be farther from the second portion 322 of the via among the two partial turns of the innermost turn 312i of the second coil pattern 312 and the second inner turn 312m may be longer than a distance G4 between a partial turn (e.g., the first half turn based on FIG. 4A) electrically connected to be closer to the second portion 322 of the via among the two partial turns of the innermost turn 312i of the second coil and the second inner turn 312m. Each of G4 and G7 may be about 8 μm, but is not limited thereto. G5 of FIG. 4E may be shorter than G5 of FIG. 4D and may be substantially equal to G4 and G7, respectively.

Referring to FIG. 4E, a turn length (about 87.5% based on FIG. 4E) of a partial turn having a smaller width among the two partial turns of the innermost turns 311i and 312i of the first and second coil patterns may be three times or more (about 8 times based on FIG. 4E) a turn length (about 12.5% based on FIG. 4E) of a partial turn having greater widths (W5 and W16) among the two partial turns of the innermost turn 312i of the first coil pattern. Here, a point between the partial turn having greater widths W5 and W16 (about 12.5% based on FIG. 4E) and the partial turn having a smaller width is a point at which the widths W5 and W16 start to become greater. That is, the point at which the width of the innermost turns 311i and 312i start to become greater may be different from a point at which the width of the innermost turns 311i and 312i of FIGS. 4A to 4C start to become greater.

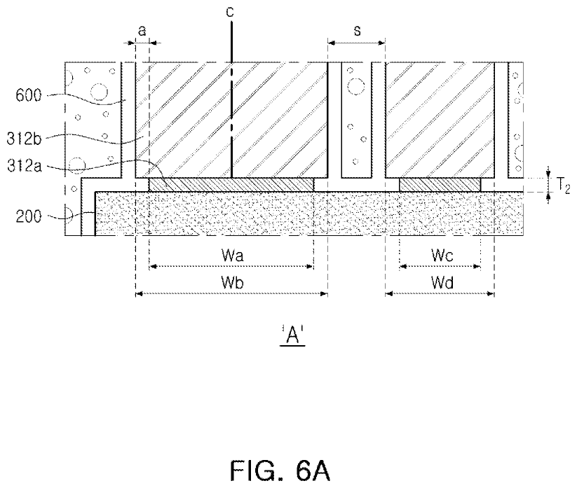

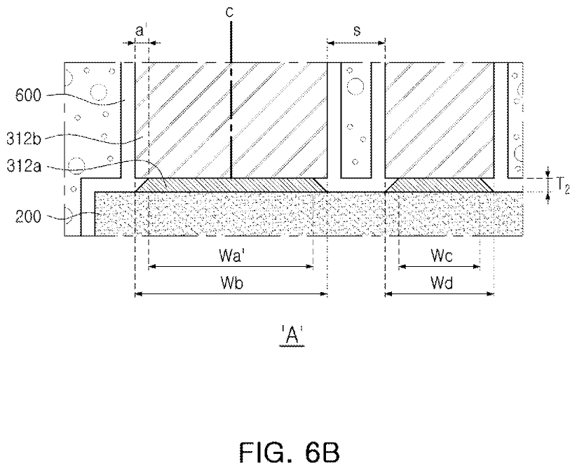

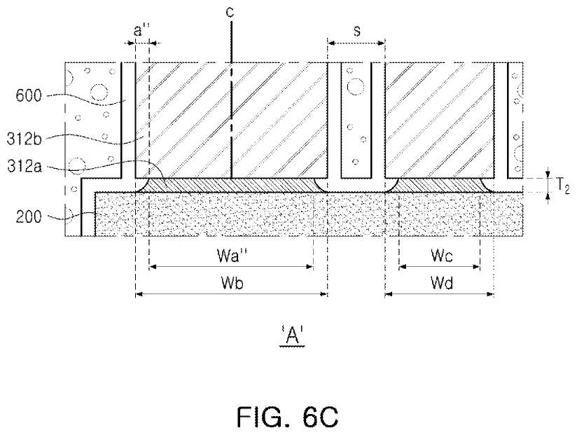

Referring to FIGS. 2 and 6A, an aspect ratio (A/R) of each of the first and second coil patterns 311 and 312 may be 4 or greater. The aspect ratio may be a value obtained by dividing the width Wb by the thickness T1 of each of the first and second coil patterns 311 and 312. The possibility of collapsing or loosening of the first and second coil patterns 311 and 312 may increase as the aspect ratio increases, but the first and second upper and lower matching portions 331 and 332 may reduce the possibility of collapsing or loosening of the first and second coil patterns 311 and 312.

Therefore, the aspect ratio of the first and second coil patterns 311 and 312 may efficiently increase, and the coil component 1000 according to an exemplary embodiment in the present disclosure may have large inductance compared to the size thereof or increase energy efficiency. For example, the thickness T₁ may be 75 μm or more and 88 μm or less, and the width Wb may be 15 μm. The width Wb of the aspect ratio is the width (W2, W6, W7, W14, W15, and W17 of FIG. 4A) of a portion of the first and second coil patterns 311 and 312 in which the first and second upper and lower matching portions 331 and 332 are not present.

Referring to FIGS. 2 and 6A, the first and second coil patterns 311 and 312 may include first conductive layers 311a and 312a disposed to contact one surface of the support member 200 and second conductive layers 311b and 312b spaced apart from one surface of the support member 200 and disposed on the first conductive layers 311a and 312a, respectively. Meanwhile, in the following, in order to avoid a redundant description, the first conductive layer and the second conductive layer will be described based on the second coil pattern 312, but this description will be applied to the first coil pattern 311 as it is.

Based on the direction of FIGS. 2 and 6A, the second coil pattern 312 includes the first conductive layer 312a disposed to be in contact with the upper surface of the support member 200 and the second conductive layer 312b disposed on the first conductive layer 312a and spaced apart from the upper surface of the support member 200.

The first conductive layer 312a may be formed from a seed layer for forming the second conductive layer 312b by electroplating. The seed layer may be formed by performing electroless plating or sputtering on the support member 200. When the seed layer is formed by sputtering or the like, at least a portion of the material constituting the first conductive layer 312a may penetrate into the support member 200. This may be confirmed by the fact that a concentration of the metal material constituting the first conductive layer 312a in the support member 200 varies in the thickness direction T of the body 100.

The first conductive layer 312a may include at least one of molybdenum (Mo), titanium (Ti), chromium (Cr), and copper (Cu). The first conductive layer 312a may have a multilayer structure, such as molybdenum (Mo)/titanium (Ti), but is not limited thereto.

The second conductive layer 312b may be formed by forming a plating resist having an opening in the seed layer and then filling the opening of the plating resist with a conductive material through electroplating.

The second conductive layer 312b may include copper (Cu). For example, the second conductive layer 312b may be formed of copper (Cu) through electrolytic copper plating, but the scope of the present disclosure is not limited thereto. The second conductive layer 312b and the first conductive layer 312a may be formed of different metal materials. The second conductive layer 312b may be formed of a single layer through a single electroplating process or a plurality of layers through a plurality of electroplating processes.

Referring to FIG. 6A, based on a cross-section, perpendicular to one surface of the support member 200, one side surface of the first conductive layer 312a is disposed to be closer to the center C of the second conductive layer 312b in the width direction than one side surface of the second conductive layer 312b. Specifically, since a distance a from one side surface of the second conductive layer 312b to one side surface of the first conductive layer 312a exceeds 0, one side surface of the first conductive layer 312a is disposed to be closer to the center C of the second conductive layer 312b in the width direction than one side surface of the second conductive layer 312b. As a result, the width Wa of the first conductive layer 312a is smaller than the width Wb of the second conductive layer 312b. Meanwhile, the other side surface of the first conductive layer 312a facing one side surface of the first conductive layer 312a is disposed to be closer to the center C of the second conductive layer 312b in the width direction than the other side surface of the second conductive layer 312b. The first conductive layer 312a is formed by forming the second conductive layer 312b on the seed layer, chemically removing the plating resist using a stripping solution, and selectively removing the seed layer using a seed etchant. The seed etchant may react with the seed layer and may not react with the electroplating layer that is the second conductive layer 312b. As a result, the first conductive layer 312a, which is formed by selectively removing the seed layer, may have one side surface disposed on an inner side than the one side surface of the second conductive layer 312b.

Referring to FIG. 6A, based on a cross-section, perpendicular to one surface of the support member 200, the ratio of the distance a from one side surface of the second conductive layer 312b to one side surface of the first conductive layer 312a to the width Wb of the second conductive layer 312b may exceed 0 and less than 0.45, and the ratio of the width Wa of the first conductive layer 312a to the width Wb of the second conductive layer 312b may exceed 011 and less than 1, but is not limited thereto.

In the coil component 1000 according to the present exemplary embodiment, a plating resist removal process and a selective seed layer removal process may be performed using a chemical solution. That is, the plating resist may be removed with a stripper or a first etchant, and the seed layer may be removed with a second etchant or a seed etchant.

Therefore, compared to the case of removing the plating resist and the seed layer together with a laser, it is possible to prevent the support member 200 from being damaged and to maintain the rigidity of the support member 200, but is not limited thereto.

In addition, in the coil component according to the present exemplary embodiment, the seed layer and the electroplating layer may be formed of different metals, and the seed etchant may react with the seed layer and may not react with the electroplating layer. Therefore, in the selective seed layer removal process, conductor loss of the second conductive layer 312b, which is the electroplating layer, may not occur, and thus, degradation of component characteristics may be prevented, but is not limited thereto.

Referring to FIGS. 4B and 4C, in the first and second modified examples of the coil component according to an exemplary embodiment in the present disclosure, based on a cross-section, perpendicular to one surface of the support member 200, one side surface of the first conductive layer 312a is disposed to be closer to the center C of the second conductive layer 312b in the width direction on the other surface side of the first conductive layer 312a contacting the second conductive layer 312b than on one surface side of the first conductive layer 312a contacting the support member 200. That is, the widths Wa′ and Wa″ of the first conductive layer 312a may increase downwardly based on the directions of FIGS. 4B and 4C. In the process of selectively removing the seed layer with a seed etchant, the upper side of the seed layer is exposed to the seed etchant for a relatively long period of time compared to the lower side of the seed layer based on the thickness direction of the seed layer. Therefore, the widths Wa′ and Wa″ of the first conductive layer formed by selectively etching the seed layer may increase downwardly.

Meanwhile, referring to FIGS. 6A to 6C, based on the cross-section, perpendicular to one surface of the support member 200, in the case of the present modified examples, one side surface of the first conductive layer 312a has a curved shape. Therefore, in the present modified examples, that one side surface of the first conductive layer 312a is disposed to be closer to the center C of the second conductive layer 312b in the width direction than one side surface of the second conductive layer 312b, may mean that an upper region of one side surface of the first conductive layer 312a is disposed to be closer to the center C of the second conductive layer 312b in the width direction than the one side surface of the second conductive layer 312b based on the directions of FIGS. 6B and 6C. In addition, in the present modified examples, the distances a′ and a″ from one side surface of the second conductive layer 312b to one side surface of the first conductive layer 312a may mean a distance from one side surface of the second conductive layer 312b to the upper region of one side surface of the first conductive layer 312a.

In the second modified example of the coil component according to an exemplary embodiment in the present disclosure, on one surface side of the first conductive layer, one side surface of the first conductive layer is disposed outside one side surface of the second conductive layer. That is, referring to FIG. 6C, based on the cross-section, perpendicular to one surface of the support member 200, a lower portion of one side surface of the first conductive layer 312a is disposed outside the one side surface of the second conductive layer 312b. Accordingly, a width of the lower portion of the first conductive layer 312a may be greater than that of the second conductive layer 312b.

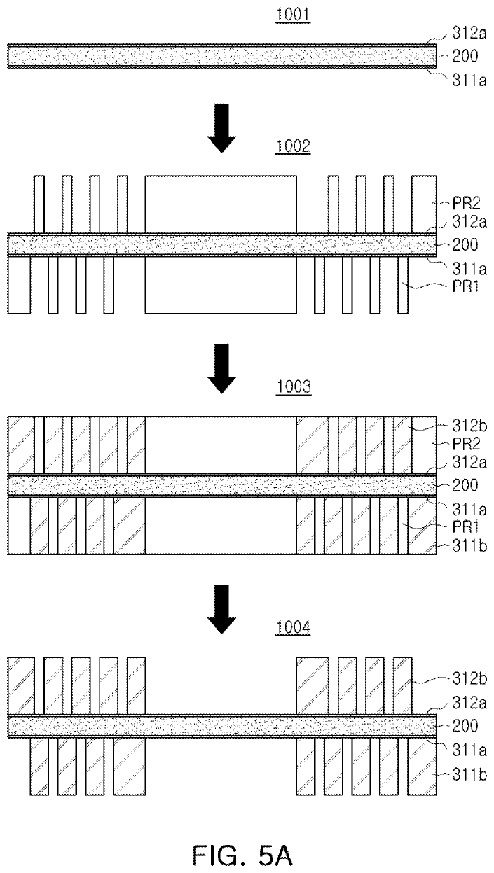

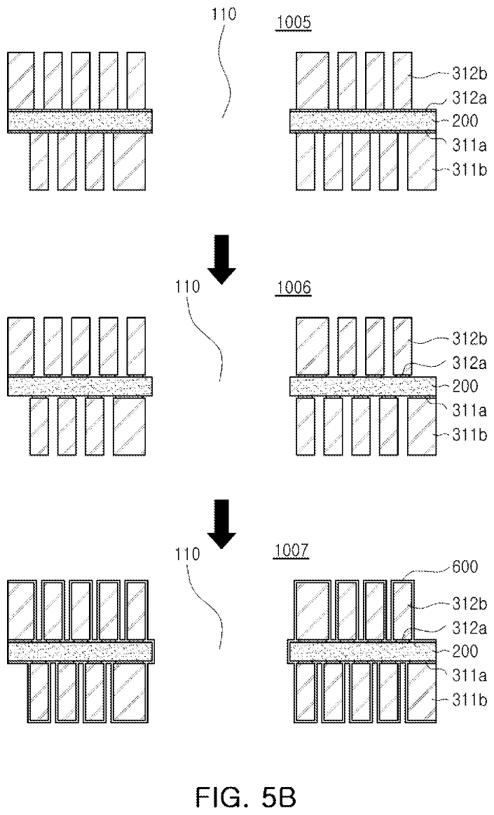

Referring to FIGS. 5A and 5B, the coil component according to an exemplary embodiment in the present disclosure may be manufactured by sequentially performing a first operation 1001, a second operation 1002, a third operation 1003, a fourth operation 1004, a fifth operation 1005, a sixth operation 1006, and a seventh operation 1007, but is not limited thereto.

The first operation 1001 may be an operation of preparing the support member 200 having the first conductive layers 311a and 312a formed on the upper and lower surfaces thereof.

The second operation 1002 may be an operation of forming plating resists PR1 and PR2 on outer surfaces of the first conductive layers 311a and 312a. The plating resists PR1 and PR2 may be formed by forming a plating resist formation material on the first conductive layers 311a and 312a and then performing a photolithography process, so that the plating resists PR1 and PR2 may be formed to include an insulating wall disposed between an opening formed to have a planar spiral shape having a plurality of turns and an opening adjacent thereto. The plating resists PR1 and PR2 may be formed by coating a liquid photosensitive material on the first conductive layers 311a and 312a or stacking a sheet-type photosensitive material on the first conductive layers 311a and 312a. A width of the opening of the plating resists PR1 and PR2 (or a separation distance between adjacent insulating walls) corresponds to the width of the first and second coil patterns, and a width of an insulating wall corresponds to a separation distance between the turns of the first and second coil patterns described above. The thickness of the insulating wall corresponds to the heights of the first and second coil patterns described above. The plating resists PR1 and PR2 include a photo imageable dielectric (PID) that may be stripped by a stripping solution. For example, the plating resists PR1 and PR2 may include a photosensitive material including a cyclic ketone compound and an ether compound having a hydroxyl group as main components, and in this case, the cyclic ketone compound may be, for example, cyclopentanone, and the ether compound having a hydroxyl group may be, for example, polypropylene glycol monomethyl ether and the like. Alternatively, the plating resists PR1 and PR2 may include a photosensitive material including a bisphenol-based epoxy resin as a main component. In this case, the bisphenol-based epoxy resin may be, for example, bisphenol A novolak epoxy resin, bisphenol A diglycidyl ether bisphenol A polymer resin or the like. However, the scope of the present disclosure is not limited thereto, and any of the plating resists PR1 and PR2 may be applied as long as they may be stripped by a stripping solution.

The third operation 1003 may be an operation of filling the openings of the plating resists PR1 and PR2 with the second conductive layers 311b and 312b. For example, the second conductive layers 311b and 312b may be formed by electroplating, and the heights of the second conductive layers 311b and 312b may be slightly shorter than the heights of the plating resists PR1 and PR2. The widths of the second conductive layers 311b and 312b may be substantially the same as widths of the openings of the plating resists PR1 and PR2.

The fourth operation 1004 may be an operation of removing the plating resists PR1 and PR2.

The fifth operation 1005 may be an operation of forming the core 110 by removing a portion of the support member 200. The core 110 may pass through the first and second coil patterns 311 and 312 and the support member 200.

The sixth operation 1006 may be an operation of removing portions of the first conductive layers 311a and 312a (the portions that do not overlap the second conductive layer in the vertical direction). For example, the sixth operation 1006 may include using an etchant rarely reacting with a metal (e.g., copper) included in the second conductive layers 311b and 312b and selectively reacting with a metal (molybdenum) included in the first conductive layers 311a and 312a. Alternatively, the sixth operation 1006 may include locally irradiating the first conductive layers 311a and 312a with a laser.

At least one of the fifth and sixth operations 1005 and 1006 may be a desmear process. If the geometrical stability of the first and second coil patterns 311 and 312 is too low, the formation of the core 110 or the removal of a portion of the first conductive layers 311a and 312a may cause the first and second coil patterns 311 and 312 to collapse or loosen, but the coil component according to an exemplary embodiment in the present disclosure may improve the geometrical stability of the first and second coil patterns 311 and 312.

The seventh operation 1007 may be an operation of forming the insulating film 600 on the surface of the first and second coil patterns 311 and 312 and/or the support member 200. The insulating film 600 may serve to insulate the first and second coil patterns 311 and 312 from the body 100 and may include a known insulating material, such as parylene. Any insulating material may be included in the insulating film 600, and there is no particular limitation. The insulating film 600 may be formed by a method, such as vapor deposition, but is not limited thereto, and may be formed by laminating insulating films on both sides of the support member 200. In the former case, the insulating film 600 may be formed in the form of a conformal film along the surfaces of the support member 200 and the first and second coil patterns 311 and 312. In the latter case, the insulating film 600 may be formed to fill spaces between adjacent turns of the first and second coil patterns 311 and 312. Meanwhile, in the present disclosure, the insulating film 600 may be an optional component, and thus, if the body 100 secures sufficient insulation resistance under the operating conditions of the coil component according to the present exemplary embodiment, the insulating film 600 may be omitted.

Thereafter, an operation of sequentially forming the body 100 and the external electrodes 400 and 500 of FIGS. 1 to 3 may be performed.

Meanwhile, W1, W2, W3, W4, W5, W6, W7, W8, W9, W11, W12, W13, W14, W15, W16, W17, W18, W19, G4, G5, G7, G14, G15, G16, and G17 may be measured as average values of dimensions corresponding to corresponding portions in an L-W cross-section of the coil component formed by polishing the coil component in the T direction, and T1, T2, Wa, Wb, Wc, Wd, a, c, and s in the present disclosure may be measured as average values of sizes of corresponding portions in the WT cross-section (or the LT cross-section) of coil component formed by grinding the coil component in the L direction (or W direction). For example, the WT cross-section and the LT cross-section may be applied to analysis using at least one of a transmission electron microscopy (TEM), an atomic force microscope (AFM), a scanning electron microscope (SEM), an optical microscope, and a surface profiler, and the sizes may be measured by visual inspection or image processing (e.g., pixel identification based on color or brightness of pixels, pixel value filtering for pixel identification efficiency, distance integration between identified pixels, etc.).

Since the coil component according to an exemplary embodiment in the present disclosure may improve the geometrical stability of the coil pattern and may be advantageous to increase the aspect ratio of the coil pattern, the coil component may have large inductance compared to the size of the coil component or increase energy efficiency.

While example exemplary embodiments have been shown and described above, it will be apparent to those skilled in the art that modifications and variations could be made without departing from the scope of the present disclosure as defined by the appended claims.

What is claimed is:

1. A coil component comprising:
a support member;
a first coil pattern disposed on one surface of the support member and having a plurality of turns;
a second coil pattern disposed on the other surface of the support member and having a plurality of turns;
a body in which the support member and the first and second coil patterns are embedded and having first and second surfaces facing each other in a first direction, third and further surfaces facing each other in a second direction, and fifth and sixth surfaces facing each other in a third direction; and
a via extending in the third direction and connecting the first and second coil patterns,
wherein an innermost turn of the plurality of turns of the first coil pattern includes a first half turn connected to the via and a second half turn connected to the first half turn,
in the first-third direction cross-section of the body cut in the center thereof in the second direction, the width of the first half turn is smaller than the width of the second half turn, and the width of the second half turn in the first direction-third direction cross-section is greater than the width of the region where the first and second half turns are connected.

2. The coil component according to claim 1, wherein
an innermost turn of the plurality of turns of the second coil pattern includes a first half turn connected to the via and a second half turn connected to the first half turn of the second coil pattern,
in the first-third direction cross-section of the body cut in the center thereof in the second direction, the width of the first half turn of the second coil pattern is smaller than the width of the second half turn of the second coil pattern, and
the width of the second half turn of the second coil pattern in the first direction-third direction cross-section is greater than the width of the region where the first and second half turns of the second coil pattern are connected.

3. The coil component according to claim 1, wherein
the width of the second half turn of the first coil pattern narrows as it is closer to the first half turn of the first coil pattern.

4. The coil component according to claim 2, wherein
the width of the second half turn of the second coil pattern narrows as it is closer to the first half turn of the second coil pattern.

5. The coil component according to claim 2, wherein
the width of the second half turn of the first coil pattern narrows as it is closer to the first half turn of the second coil pattern, and
the width of the second half turn of the second coil pattern narrows as it is closer to the first half turn of the first coil pattern.

6. The coil component according to claim 2, wherein
an average width of the first half turn of the first coil pattern is greater than an average width of a second inner turn of the first coil pattern, and
an average width of the first half turn of the second coil pattern is greater than an average width of a second inner turn of the second coil pattern.

7. The coil component according to claim 1, wherein
an average width of an outermost turn of the plurality of turns of the first coil pattern is greater than an average width of a second inner turn of the first coil pattern, and
an average width of an outermost turn of the plurality of turns of the second coil pattern is greater than an average width of a second inner turn of the second coil pattern.

8. The coil component according to claim 1, wherein
the first coil pattern further includes a first lead-out pattern connected to the plurality of turns of the first coil pattern and exposed to a surface of the body,
the second coil pattern further includes a second lead-out pattern connected to the plurality of turns of the second coil pattern and exposed to another surface of the body,
an edge surrounding the first lead-out pattern at an outermost turn of the plurality of turns of the first coil pattern has a step,
an edge surrounding the second lead-out pattern at an outermost turn of the plurality of turns of the second coil pattern has a step,
a width of the first lead-out pattern is nine times or greater a width of a second inner turn of the first coil pattern, and
a width of the second lead-out pattern is nine times or greater a width of a second inner turn of the second coil pattern.

9. The coil component according to claim 2, wherein
an edge surrounding the via in the second half turn of the first coil pattern has a step, and
an edge surrounding the via in the second half turn of the second coil pattern has a step.

10. The coil component according to claim 1, wherein
the body includes a core passing through the first and second coil patterns and the support member, and
an aspect ratio (A/R) of each of the first and second coil patterns is 4 or greater.

11. The coil component according to claim 1, wherein
the first and second coil patterns each include:
a first conductive layer disposed to be in contact with the support member; and
a second conductive layer including a metal different from a metal included in the first conductive layer and disposed on the first conductive layer to be spaced apart from the support member,
wherein, in view of a cross-section, perpendicular to the one surface of the support member, one side surface of the first conductive layer is disposed to be closer to a center of the second conductive layer in a width direction than one side surface of the second conductive layer.

12. The coil component according to claim 2, wherein
a distance between the second half turn of the first coil pattern and a second inner turn of the first coil pattern is greater than a distance between the first half turn of the first coil pattern and the second inner turn of the first coil pattern, and
a distance between the second half turn of the second coil pattern and a second inner turn of the second coil pattern is greater than a distance between the first half turn of the second coil pattern and the second inner turn of the second coil pattern.

13. The coil component according to claim 1, wherein
the first and second half turns of the first coil pattern have curved regions, respectively, facing each other in the first direction, and
an average width of the curved region of the first half turn is smaller than an average width of the curved region of the second half turn.

14. The coil component according to claim 2, wherein
the first and second half turns of the second coil pattern have curved regions, respectively, facing each other in the first direction, and
an average width of the curved region of the first half turn is smaller than an average width of the second half turn.
